(19) United States
(12) Patent Application Publication
(10) Pub. No.: US 2017/0166464 A1
(43) Pub. Date: Jun. 15, 2017

(54) METHOD OF TREATING THE WASTEWATER FROM ISOPHORONE PRODUCTION BY HIGH-PRESSURE WET OXIDATION

(71) Applicants: Yue CHANG, Darmstadt (DE); Manfred KRECZINSKI, Herne (DE); Martin MAIER, Herne (DE); Matthias WOYCIECHOWSKI, Langenselbold (DE)

(72) Inventors: Yue CHANG, Darmstadt (DE); Manfred KRECZINSKI, Herne (DE); Martin MAIER, Herne (DE); Matthias WOYCIECHOWSKI, Langenselbold (DE)

(73) Assignee: Evonik Degussa GmbH, Essen (DE)

(21) Appl. No.: 15/373,949

(22) Filed: Dec. 9, 2016

(30) Foreign Application Priority Data
Dec. 9, 2015 (EP) 15198686

(51) Int. Cl. C02F 1/72; C02F 1/74

(52) U.S. Cl. CPC C02F 1/727; C02F 1/74; C02F 1/725; C02F 2103/36

(57) ABSTRACT

The invention relates to the treatment of the wastewater from isophorone production (IP) by high-pressure wet oxidation.

### BACKGROUND OF THE INVENTION

Field of the Invention

The invention relates to the treatment of the wastewater from isophorone production (IP) by high-pressure wet oxidation.

Discussion of the Background

WO2012/076314 discloses a method of preparing isophorone (3,5,5-trimethyl-2-cyclohexen-1-one).

WO2012/076314 and WO 2012/156187 disclose a method of preparing isophorone wherein the water from the bottoms of the distillative treatment of the aqueous fraction is subjected to a flash evaporation and the purified water generated is recycled into the process for preparing isophorone. The wastewater generated is not purified further.

The European patent application having filing number 14195357.0-1351 describes a method of treating impurified wastewater from the preparation of isophorone (IP), isophoronenitrile (IPN) and isophoronediamine (IPDA), wherein the wastewater from the preparation of isophorone may be treated by an oxidation.

### SUMMARY OF THE INVENTION

The present invention has for its object to improve wastewater quality compared to the prior art.

It has been found that the organic ingredients in the wastewater from isophorone production can be digested by an oxidation with oxygen. This high-pressure wet oxidation can substantially improve the biodegradability of the wastewater from IP production.

### DETAILED DESCRIPTION OF THE INVENTION

The invention provides a method of treating the wastewater from isophorone production by oxidation of the alkaline wastewater at a pH of 8 to 14 under action of pure oxygen and/or oxygen in compressed air at a pressure of 5-50 bar.

The wastewater from isophorone production is a wastewater comprising a great many complex organic compounds. This wastewater is highly basic and usually has a pH higher than 11. The wastewater additionally has only a limited biodegradability, i.e. <60%, even after long adaptation times in municipal water treatment plants.

In the prior art such as in WO2012/076314 and WO 2012/156187 the wastewater from production is treated as described therein and discharged to drain.

It was found that an oxidative treatment under pressure, high-pressure wet oxidation, can digest and directly partly and/or completely oxidize complex organic compounds in the wastewater to afford primarily CO₂ and water.

### Description of the High-Pressure Wet Oxidation

The wastewater from the wastewater column from the IP production process has a system pressure of 20 to 40 bar and a temperature of 200-300° C. This wastewater is introduced into a reactor directly or after a little cooling and subjected to oxidative treatment under action of pure oxygen and/or oxygen from compressed air. The oxidation reactor is operated at a pressure identical to or lower than the pressure in the IP production process. The oxygen (pure oxygen or air oxygen) is supplied to the oxidation reactor at this pressure. This is accomplished for example from a compressed gas system or by means of a pressure increase, for example via a compressor. The preferred pressure is 20-40 bar, preferably 30-36 bar. The temperature is up to 50 K below the boiling temperature at the prevailing pressure. The preferred operating temperature is 150-250° C. The wastewater is introduced into the oxidation reactor and oxidized via the high-pressure wet oxidation according to the required residence time of 0.5 to 5 hours, preferably 1 to 3 hours, and then discharged from the column. The pure oxygen/the air oxygen is preferably introduced in the bottom region of the pressure vessel via a distributor, for example perforated trays, distributor pipes comprising holes, frit. The distributor distributes the oxygen uniformly in the reactor space so that the oxidative conversion of oxygen to organic compounds is ensured. Intermediate trays may be installed in the reactor to allow continued contacting of oxygen and organic compounds in the wastewater, to ensure the hydraulic residence times and to maximize the oxidative conversion.

The high-pressure wet oxidation is operated in the strongly alkaline range and preferably without catalyst. The pH range during the oxidation varies from pH 8 to 14, preferably from pH 11 to 14. A suitable catalyst may be added to the reaction to accelerate the reaction.

The high-pressure wet oxidation may be carried out in continuous or batchwise fashion as a single- or multistage through-flow process. The hydraulic residence time is 0.5 to 5 hours, preferably 1 to 3 hours or longer as required by the process. A multistage continuous reactor concept is particularly preferred here, at least two reactors being arranged in series.

The oxidation of the alkaline wastewater is preferably carried out in the temperature range of 150-250° C. and at a pH of 11 to 14 and at a pressure of 20-40 bar.

The organic compounds are converted into CO₂ and H₂O and into reduced organic compounds. After the high-pressure wet oxidation the water may be cooled using the energy content without any danger of solids formation.

The reduced compounds may accordingly be made more readily available for the microorganisms. Compared to freshly generated and untreated IP wastewater the biodegradability of the IP wastewater is improved by up to 50%, generally by 10-20%, measured according to standard methods of measurement (Zahn-Wellens test DIN EN ISO 9888/OECD302B).

This improvement rate contributes substantially to improved environmental performance/enhances production security in case of a change in regulatory requirements concerning environmentally-relevant emissions permits.

Should wastewaters other than IP wastewater from step B) arrive in the oxidation appropriate pH adjustment to the reaction must be tested and adhered to. In the present case wastewaters from the production of IPN and/or IPDA are fed into IP wastewater. Since both bound and free cyanides are present in wastewaters from IPN and IPDA, this must be effected at pH>9.5 so that no HCN gas is stripped out during the oxidation.

Having generally described this invention, a further understanding can be obtained by reference to certain specific examples which are provided herein for purposes of illustration only, and are not intended to be limiting unless otherwise specified.

European patent application EP15198686 filed Dec. 9, 2015, is incorporated herein by reference.

Numerous modifications and variations on the present invention are possible in light of the above teachings. It is therefore to be understood that within the scope of the appended claims, the invention may be practiced otherwise than as specifically described herein.

1. A method of treating wastewater from isophorone production, said method comprising:
oxidizing an alkaline wastewater at a pH of 8 to 14 under action of pure oxygen and/or oxygen in compressed air at a pressure of 5-50 bar.

2. The method according to claim 1, wherein the oxidation of the alkaline wastewater is carried out at a pH of 11 to 14.

3. The method according to claim 1, wherein the oxidation of the alkaline wastewater is carried out at a pressure of 20-40 bar.

4. The method according to claim 1, wherein the oxidation of the alkaline wastewater is carried out at an operating temperature of 150-250° C.

5. The method according to claim 1, wherein a residence time in the oxidation reactor during the oxidation of the alkaline wastewater is from 0.5 to 5 hours.

6. The method according to claim 1, wherein the oxidation of the alkaline wastewater is carried out in the temperature range of 150-250° C. and at a pH of 11 to 14 and at a pressure of 20-40 bar.

7. The method according to claim 1, wherein the oxidation of the alkaline wastewater is carried out in the presence of a catalyst.

8. The method according to claim 1, wherein the pure oxygen and/or the oxygen in compressed air is introduced in a bottom region of a pressure vessel via a distributor.

9. The method according to claim 1, wherein the pure oxygen and/or the oxygen in compressed air is introduced in a bottom region of a pressure vessel via at least one distributor selected from the group consisting of a perforated tray, a distributor pipe comprising holes, and a frit.
